(19) United States
(12) Patent Application Publication
(10) Pub. No.: US 2005/0172886 A1
(43) Pub. Date: Aug. 11, 2005

(54) Bookmark

(76) Inventor: FrancineKay Marcus, Wake Forest, NC (US)

Correspondence Address: Robert G. Rosenthal, Esq., Suite 200, 5856 Faringdon Place, Raleigh, NC, 27609, US

(21) Appl. No.: 11/103,842

(22) Filed: Apr. 12, 2005

Related U.S. Application Data
(63) Continuation-in-part of application No. 10/747,645, filed on Dec. 29, 2003.

(51) Int. Cl. B42D 9/00

(52) U.S. Cl. 116/238

(57) ABSTRACT

A bookmark is adapted to be placed proximate the spine and the binding of a book and being of the type that protects the physical integrity of the book. The bookmark comprises an elastic band formed into an endless loop and wherein the elastic band is adapted to encircle the spine and the binding of the book. A decorative element is mounted on the elastic band at a preselected location such that the decorative element is positioned proximate the outer spine of the book when the bookmark is in use.

### RELATED APPLICATION

This application is a continuation-in-part of U.S. patent application Ser. No. 10/747,645 filed Dec. 29, 2003.

### FIELD OF THE INVENTION

This invention relates generally to the field of bookmarks and more particularly to book marks of the type that will not damage the book.

### FIELD OF THE INVENTION

Bookmarks, i.e., devices to mark a reader's place in a book, are well-known and have probably been in use since the invention of the book. Bookmarks take a variety of forms. For example, perhaps the simplest form of bookmark is when the reader “turns down” or folds a corner of the page over to mark his place. This is less than acceptable as the page is permanently damaged and further, subsequent readers can become confused as to which folds represents the place where they stopped reading. Another type of bookmark is one that is clipped onto the page. This can be as simple as a paper clip or other types of clips that include decorative elements. However, these bookmarks also permanently deform the page and accidental page tears can occur.

Another type of bookmark is a thin marker which is inserted between the pages where the reader desires to mark his place. This marker often takes the form of a ribbon, a thin piece of leather or a heavy paper stock. These bookmarks often contain a decorative design. However, this type of bookmark often becomes dislodged from the volume when the book is accidentally dropped or other shifting occurs. Also, if the ribbon style bookmark is too thick, damage to the spine can occur.

With the foregoing in mind, it is an object of the present invention to overcome the drawbacks and deficiencies of the prior art.

Another object of the present invention is to provide an improved bookmark that does not deform or otherwise damage the printed page.

Still another object of the present invention is to provide an improved bookmark that does not cause damage to the spine of the book.

Yet another object of the present invention is to provide an improved bookmark that will not become accidentally dislodged from the book.

A further object of the invention is to provide an improved bookmark that provides an identifier of place which is unique to the particular reader.

A still further object of the present invention is to provide the reader with a personal and distinctive ornament for their book.

### SUMMARY OF THE INVENTION

The benefits and advantages of the present invention are achieved by a bookmark that is adapted to be placed proximate the spine and the binding of a book. The bookmark comprises an elastic band formed into an endless loop and the elastic band is adapted to encircle the inner spine and the outer spine of the book. A decorative element or elements are mounted on the elastic band at a preselected location and further, the decorative element is adapted to be positioned proximate the outer spine of the book.

### BRIEF DESCRIPTION OF THE DRAWINGS

Some of the features and advantages of the invention having been briefly stated, others will appear from the detailed specification which follows, when taken in connection with the accompanying drawings in which

FIG. 1 is a perspective view of the a book spine with the bookmark according to the invention positioned thereon.

FIG. 2 is a plan view of the bookmark according to the present invention.

### DETAILED DESCRIPTION OF THE ILLUSTRATED EMBODIMENT

While the present invention will be described more fully hereinafter with reference to the accompanying drawings, in wihch a particular embodiment is shown, it is to be understood at the outset that persons skilled in the art may modify the invention herein described while still achieving the favorable results of this invention. Accordingly, the description which follows is to be understood as a broad teaching disclosure directed to persons of skill in the appropriate arts and not as limiting upon the present invention.

Referring now more particularly to the drawings, the bookmark according to the present invention is generally indicated at 10. An elastic band 20 is formed into an endless loop. As will be explained in greater detail herein below, an elastic band approximately 12 inches in length will accommodate most books. In the preferred embodiment, the elastic band comprises 0.5 mm elastic cord or thread which may be colored to enhance aesthetic appeal.

A decorative element 30 is mounted on the elastic band at a preselected location. More specifically, the decorative element may comprise a bead, charm, seashell button or other decoration having a hole defining an opening is mounted on the band. The decorative element may comprise a number or combination of the foregoing. In the illustrated embodiment, the decorative elements are maintained in position by knots 40 in the elastic band 20 on either side of decorative elements 30. In another aspect of the invention, that portion of the band upon which the decorative elements are positioned is under tension, preferably fully stretched, as the band, over time and with use, will stretch. Tensioning the band will prevent separation of the decorative elements when stretching occurs, thus, preserving the aesthetic appearance of the bookmark. It is contemplated that other means may be employed to fix the position of the decorative elements 30 on the elastic band 20 may be used such as a quick drying glue, a drop of a liquid polymer, adhesive, a split-shot type of fastener or other similar means may be employed.

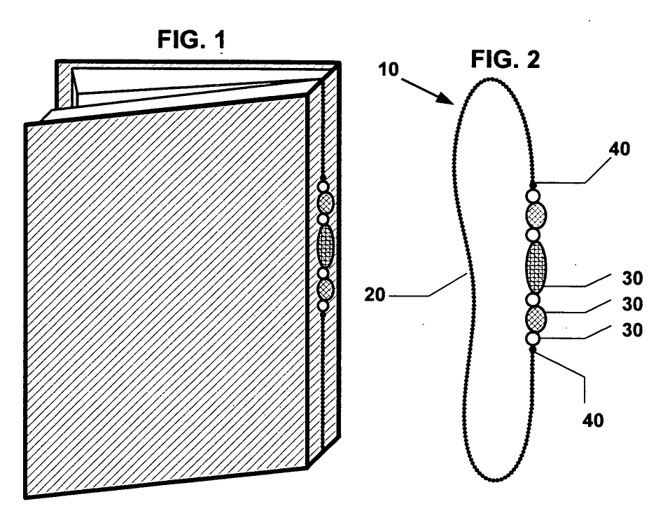

In the illustrated embodiment, the bookmark is formed by obtaining the preselected length of elastic band 20, usually twelve (12) to (14) inches, depending upon elasticity, which is well suited to the vast majority of “reading” type paperback and hardback books. The decorative elements such as in the beads in FIG. 1 and FIG. 2 are strung on the elastic band. One knot 40 of sufficient size to prevent movement of the beads beyond the knot is formed in the elastic band. The section of elastic band holding the beads is then stretched taught and a knot formed in the opposite side of the beads and the tension is then released. The opposing ends of the elastic band 20 are then connected by a knot to form the endless loop. It will be noted that other suitable means such as heat fusion, glue and the like may be used to complete formation of the endless loop, depending on the material chosen and the particular manufacturing process employed.

In use the bookmark 20 is slid over the book such that one-half of the elastic band rests between adjacent pages of a book proximate the binding and the other half of the elastic band containing the decorative elements rests on the outside of the book, proximate the spine. When it is desired to mark a new page location, the reader grips the decorative element and stretches the endless loop such that the pages can be moved thereunder to mark a new stopping place.

The foregoing embodiment and examples are to be considered illustrative rather then restrictive of the invention, and those modifications which come within the meaning and range of equivalence of the claims are to be included therein.

1. A bookmark adapted to be placed proximate the spine and the binding of a book and being of the type that protects the physical integrity of the book and comprising:
an elastic band formed into an endless loop and wherein said elastic band is adapted to encircle the inner spine and the outer spine of the book;
a decorative element mounted on said elastic band at a preselected location and wherein said decorative element is adapted to be positioned proximate the outer spine of the book.

2. The bookmark according to claim 1 wherein said decorative element comprises a bead having a bore extending there through and wherein said elastic band extends through said bore.

3. The bookmark according to claim 1 wherein the section of elastic band in proximate the decorative element is maintained under tension.

4. The bookmark according to claim 1 further including means for maintaining said decorative element in the preselected location on said elastic band.

5. The bookmark according to claim 4 wherein said means for maintaining said decorative element in the preselected location on said elastic band is selected from the group consisting of knots, adhesive, polymer beads, glue and split-shot type fasteners.

6. The bookmark according to claim 5 wherein the portion of the elastic band in contact with the decorative element is under tension and the remaining portion of said elastic band is slack when the bookmark is not in use on a book and further, wherein the elastic band is under tension, but not fully extended, when in use to mark a place in a book.
